(19) United States
(12) Patent Application Publication
(10) Pub. No.: US 2005/0167473 A1
(43) Pub. Date: Aug. 4, 2005

(54) METHOD FOR PRODUCING WEDGE-WEDGE WIRE CONNECTION

(75) Inventors: Michael Mayer, Waterloo, Ontario (CA); Heinrich Berchtold, Reussbuehl (CH)

Correspondence Address: MCCORMICK, PAULDING & HUBER LLP, CITY PLACE II, 185 ASYLUM STREET, HARTFORD, CT, 06103, US

(73) Assignee: UNAXIS INTERNATIONAL TRADING LTD., Cham (CH)

(21) Appl. No.: 10/905,438

(22) Filed: Jan. 4, 2005

(30) Foreign Application Priority Data
Jan. 9, 2004 (CH) 41/04
Mar. 29, 2004 (CH) 523/04

(51) Int. Cl. B23K 31/02

(52) U.S. Cl. 228/180.5

(57) ABSTRACT

A Ball-Wire Bonder can be used for the production of a wedge-wedge wire connection between first and second connection points when the tearing off of the wire takes place after production of the second wedge connection so that the piece of wire protruding out of the capillary points in the direction of the next wire connection to be made. The following steps are carried out in order to complete the wedge-wedge wire connection by tearing off the wire and to prepare the piece of wire protruding out of the capillary for producing the next wedge-wedge wire connection to be made: calculating a two-dimensional vector v lying in a horizontal plane that points from the desired impact point of the capillary on the first connection point of the next wedge-wedge wire connection to be made towards the desired impact point of the capillary on the second connection point of the next wedge-wedge wire connection to be made, and after attaching the wire to the second connection point, moving the capillary along a travel path that lies in a plane formed by the vector v and the vertical whereby the wire tears off on reaching the end of the travel path.

### PRIORITY CLAIM

Applicant hereby claims foreign priority under 35 U.S.C § 119 from Swiss Applications No. 41/04 filed Jan. 9, 2004 and 523/04 filed Mar. 29, 2004, the disclosures of which are herein incorporated by reference.

### FIELD OF THE INVENTION

The invention concerns a method for producing a wedge-wedge wire connection with a Wire Bonder known in the trade as a Ball-Wire Bonder.

### BACKGROUND OF THE INVENTION

A Wire Bonder is a machine with which semiconductor chips are wired after they have been mounted onto a substrate. In the trade, a distinction is made between two types of Wire Bonders that are designated as Ball-Wedge Wire Bonder, abbreviated as Ball-Wire Bonder, and Wedge-Wedge Wire Bonder, abbreviated as Wedge-Wire Bonder.

The Ball-Wire Bonder has a capillary that is clamped to the tip of a horn. The capillary serves to attach the wire to a connection point on the semiconductor chip and to a connection point on the substrate as well as to guide the wire between the two connection points. On producing the wire connection between the connection point on the semiconductor chip and the connection point on the substrate, the end of the wire protruding out of the capillary is first melted into a ball. The ball is then attached to the connection point on the semiconductor chip by means of pressure and ultrasound. In doing so, ultrasound from an ultrasonic transducer is applied to the horn. This process is called ball bonding. The wire is then pulled through to the required length, formed into a wire loop and soldered (thermocompression bonded) to the connection point on the substrate. This last sub-process is called wedge bonding. After attaching the wire to the connection point on the substrate, the wire is torn off and the next bond cycle can begin.

The Wedge-Wire Bonder has a wire guide and attach tool that also serves to attach the wire to a connection point on the semiconductor chip and to a corresponding connection point on the substrate. On producing the wire connection between the connection point on the semiconductor chip and the connection point on the substrate, the end of the wire presented by the wire guide and attach tool is attached to the connection point on the substrate by means of pressure and ultrasound. The wire is then pulled through to the required length, formed into a wire loop and soldered to the connection point on the substrate. Both sub-processes are called wedge bonding. After attaching the wire to the connection point on the substrate, the wire is torn or cut off and the next bond cycle can begin. In general, a wedge-wedge connection designates a wire connection with which on both connection points the corresponding piece of wire protruding out of the capillary is bonded to the respective connection point by means of pressure and ultrasound, generally at a higher temperature, without it previously being melted into a ball.

There is a substantial difference between the bondhead of a Wedge-Wire Bonder and the bondhead of a Ball-Wire Bonder, because with the wedge-wedge bonding process the end of the wire to be attached to the first connection point always has to run in the direction of the wire connection to be made. Therefore, with a Wedge-Wire Bonder, the horn, at the tip of which the wire guide and attach tool is secured, has to be arranged rotatably on a vertical axis. The bondhead of the Wedge-Wire Bonder has to enable movements of the wire guide and attach tool with a total of five degrees of freedom while the bondhead of a Ball-Wire Bonder only has to enable movements of the capillary with a total of three degrees of freedom.

### SUMMARY OF THE INVENTION

The invention utilizes the discovery that a Ball-Wire Bonder can also be used for the production of a wedge-wedge wire connection when the tearing off of the wire after production of the second wedge connection takes place so that the piece of wire protruding out of the capillary points in the direction of the next wire connection to be made.

Therefore, in accordance with the invention, it is proposed to program a Ball-Wire Bonder in such a way that, after attaching the wire to the second connection point, the following steps are carried out each time in order to finish production of the actual wedge-wedge wire connection by tearing off the wire and to prepare the piece of wire protruding out of the capillary for production of the next wedge-wedge wire connection:
calculation of a two-dimensional vector v lying in a horizontal plane that points from the desired impact point of the capillary on the first connection point of the next wedge-wedge wire connection to be made towards the desired impact point of the capillary on the second connection point of the next wedge-wedge wire connection to be made; and
after attaching the wire to the second connection point, moving the capillary along a travel path that lies in a plane formed between the vector v and the vertical. On attaching the wire to the second connection point, a predetermined breaking point is produced as usual at which the wire is to be torn off on reaching the end of the travel path.

Essentially, the travel path of the capillary consists of four consecutive travel movements:
a) raising the capillary by a predetermined distance Δz₁;
b) moving the capillary in horizontal direction by a predetermined distance Δw₁ in the direction defined by the vector v;
c) lowering the capillary by a predetermined distance Δz₂; and
d) moving the capillary in horizontal direction by a predetermined distance Δw₂ in the direction defined by the vector v. The distance Δw₂ is dimensioned so that the wire tears off.

The movements of the capillary in steps a), b), and c) take place with the wire clamp open and serve to align the wire in the direction of the vector v before the wire is torn off. The last step d takes place with the wire clamp closed so that the wire tears off. The wire tears off at the predetermined breaking point so that a piece of wire now protrudes out of the capillary that is aligned in the direction of the vector v.

The movements of the capillary in steps a, b and c are horizontal or vertical movements. These movements can also be superimposed on each other in order to avoid abrupt stops and therefore associated oscillations of the capillary with the advantage that the travel time of the capillary becomes shorter.

As already mentioned above, the bondhead of the Ball-Wire Bonder has a capillary that guides the wire and enables the capillary movements with three degrees of freedom, namely movements in x, y and z direction of a Cartesian system of coordinates. Different bondheads that fulfill these requirements but which are essentially differentiated in their design are known for example from the patents U.S. Pat. No. 5,114,302, U.S. Pat. No. 5,330,089 or U.S. Pat. No. 6,460,751.

The basic principle of the invention can also be used for applications with which the wire connection is produced in that the wire is first attached to the substrate and then to the semiconductor chip. With these applications it is often necessary to reinforce the connection produced between the wire and the semiconductor chip by means of additional wire material that has to be previously applied to the semiconductor chip. This is done in that a ball connection is first applied to the connection point on the semiconductor chip and the wire is immediately torn off without forming the wire connection. In the trade, the ball connection produced is designated as a “bump” or “ball-bump”. Afterwards, a ball-wedge wire connection is produced in that the piece of wire protruding out of the capillary is melted into a ball and attached to the connection point on the substrate, then the required length of wire is pulled out and in doing so the wire loop is formed and the wire is attached to the bump as a wedge connection. Such a wire connection is characterized in that it has a “ball” or “bump” at both ends. In the trade, this method is known as the Ball-Bump-Reverse-Loop method. The invention simplifies the production of wire connections for applications of this type in that it enables the wire protruding out of the capillary to be first attached as a wedge connection to the bump applied to the semiconductor chip, then to pull out the required length of wire and in doing so to simultaneously form the wire loop and to attach the wire to the connection point on the substrate as a wedge connection. Thereby a distinction is made between two procedures.

With the first procedure, all connection points on the semiconductor chip are first provided with a bump in a known way. Afterwards, the wire loops between the semiconductor chip and the substrate are produced as wedge-wedge connections as is described above.

With the second procedure, one wire connection after the other is completely produced from start to finish. The production of such a wire connection is characterized by the following steps:
melting the piece of wire protruding out of the capillary into a ball (“ball formation”);
calculating a two-dimensional vector v lying in a horizontal plane that points from the desired impact point of the capillary on the connection point on the semiconductor chip towards the desired impact point of the capillary on the connection point on the substrate;
formation of a bump by
attaching the ball to the connection point on the semiconductor chip, and
moving the capillary along a travel path that lies in a plane formed by the vector v and the vertical whereby the wire is torn off at the end of the travel path. Here, the travel path also consists of the travel movements a to d described for the first example. The bump is now attached to the connection point on the semiconductor chip and the piece of wire protruding out of the capillary points in the direction of the wire connection to be produced;
moving the capillary back over the bump that has just been produced;
attaching the piece of wire protruding out of the capillary to the bump whereby a wedge connection is created; and
pulling out the wire to the required length whereby as usual the wire is formed into a loop, and attaching the wire as a wedge connection to the connection point on the substrate.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale. In the drawings:

FIG. 1 shows schematically a Ball-Wire Bonder,

FIG. 2 shows a schematic plan view of a substrate with several semiconductor chips,

FIG. 3 shows a section from FIG. 2,

FIG. 4A-E illustrate consecutive snapshots that illustrate the tearing off of the wire and the formation of the end of the wire into the shape necessary for the next wedge connection, and

FIG. 5A-E illustrate different travel paths of the capillary,

FIG. 6 show a completed wire connection, and

FIG. 7A-F illustrate different travel paths of the capillary for the production of the wire connection shown in FIG. 6.

### DETAILED DESCRIPTION OF THE PREFERRED EMBODIMENTS

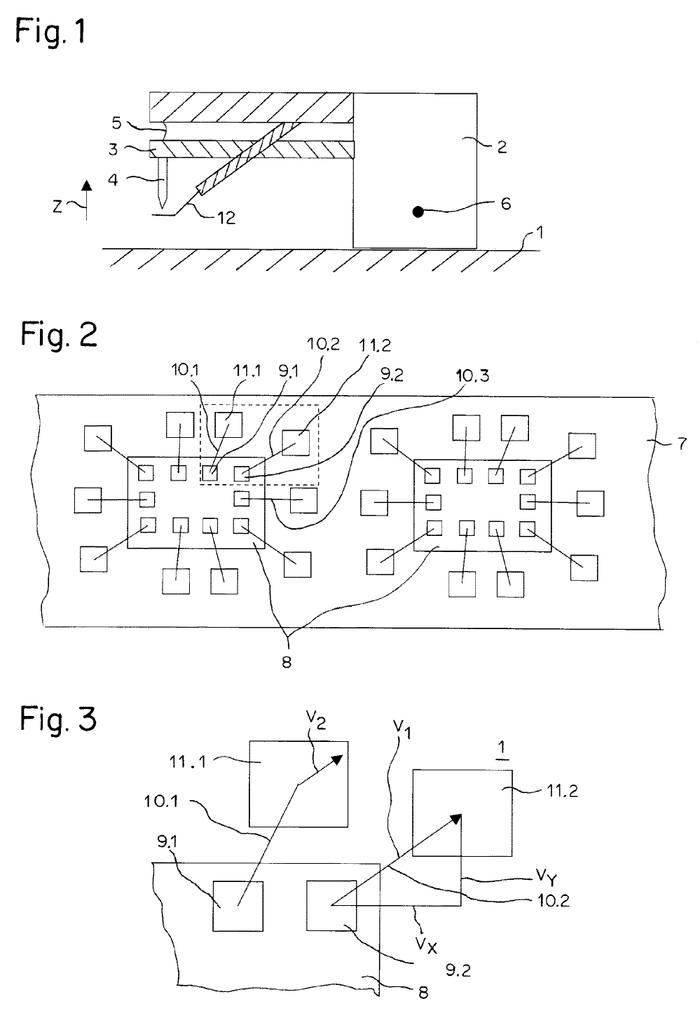

FIG. 1 shows a schematic side view of the parts of a Wire Bonder necessary for the understanding of the invention. The Ball-Wire Bonder comprises a bondhead 2 moveable in a horizontal xy plane 1 by means of two drives with a horn 3 at the tip of which a capillary 4 is clamped. The capillary 4 has a longitudinal drill hole through which the wire 5 is fed. The horn 3 can be rotated on a horizontal axis 6 by means of a third drive. The three drives therefore enable a movement of the tip of the capillary 4 from one location A to any location B. From this design results that the number n of the degrees of freedom of the capillary 4 amounts to a total of n=3. In addition, an electrode 1 2 is attached to the bondhead 2 with the aid of which it is possible to melt the piece of wire protruding out of the capillary into a ball. More details on such electrodes can be taken for example from the U.S. Pat. Nos. 6,739,494 and 6,739,493.

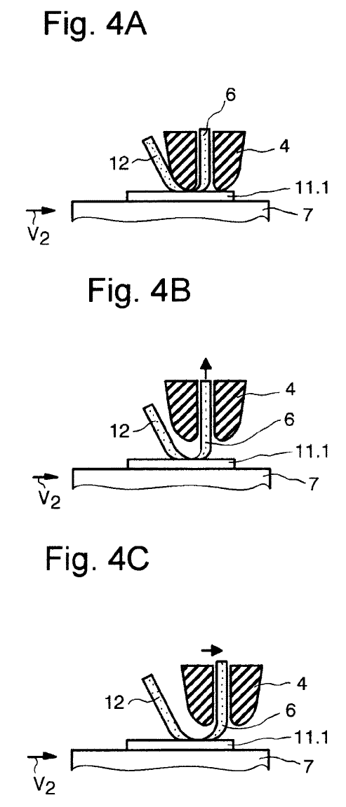

FIG. 2 shows a schematic plan view of a substrate 7 with several semiconductor chips 8 mounted on the substrate 7. The substrate 7 can also be a semiconductor chip. Each semiconductor chip 8 has a predetermined number of connection points 9.1, 9.2, etc., each of which is to be electrically connected to a corresponding connection point 11.1, 11.2, etc., on the substrate 7 via a wire connection 10.1, 10.2, etc.

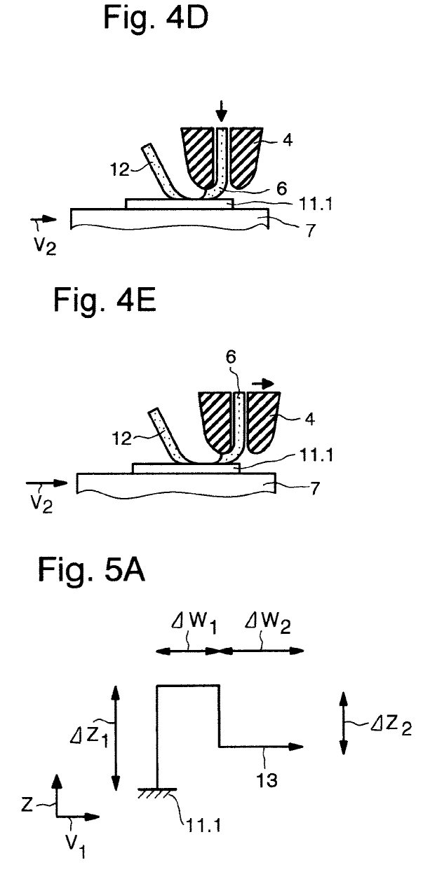

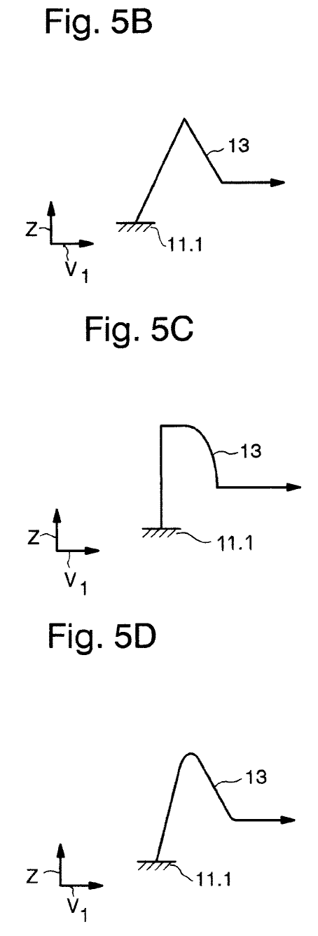

The method in accordance with the invention is now explained in detail based on FIGS. 3 and 4A to 4E. FIG. 3 shows the section bordered by a broken line in FIG. 2. The wire connection 10.1 presented on the left-hand side of FIG. 3 has been produced in so far that, with the capillary 4 of the Ball-Wire Bonder, a wire loop has been produced running from the first connection point 9.1 on the semiconductor chip 8 to the corresponding second connection point 11.1 on the substrate 7 the ends of which are soldered to the two connection points 9.1 and 11.1. However the wire 5 emerging from the capillary 4 has not yet been separated from the wire connection 10.1. The next thing is to produce the wire connection 10.2 between the two connection points 9.2 and 11.2. Therefore the two components vₓ and v_{y} of a vector v=(vₓ, v_{y}, v_{z}) are determined that lie in the horizontal xy plane and point from the first connection point 9.2 towards the second connection point 11.2: The vector v connects the desired impact points of the capillary 4 on the respective connection point 9.2 and 11.2. Generally, the two connection points 9.2 and 11.2 are located at different z heights, the z component v_{z} of the vector v is of no interest. The two components vₓ and v_{y} therefore designate a two-dimensional vector v₁ lying in the horizontal xy plane 1. When the coordinates of the desired impact point of the capillary 4 on the first connection point 9.2 are designated with (x₁, y₁, z₁) and the coordinates of the desired impact point of the capillary 4 on the second connection point 11.2 are designated with (x₂, y₂, z₂) then this results in the vector v₁ as v₁=(x₂−x₁, y₂−y₁). Also presented is a vector v₂ going out from the connection point 11.1 of the actual, not yet completed wire connection 10.1. The vector v₂ runs parallel to vector v₁ and illustrates the travel direction in the horizontal xy plane 1 that is covered by the capillary 4 in the steps explained below.

FIGS. 4A to 4E show the second connection point 11.1, the wire 5 and the capillary 4 in consecutive snapshots that illustrate the detachment of the wire 5 from the wire connection 10.1. Detachment of the wire 5 is done so that, after tearing off, the end of the wire protruding out of the capillary 4 runs parallel to the vector v₁ or v₂. The figures illustrate a vertical section in a vertical plane running parallel to the vector v₂. An arrow symbolises the travel direction of the capillary 4.

FIG. 4A shows the condition immediately after attaching the wire 5 to the second connection point 11.1. The following steps are now carried out:
the capillary 4 is raised by a predetermined distance Δz₁. This condition is shown in FIG. 4B;
the capillary 4 is moved in the horizontal direction by a predetermined distance Δw₁ in the direction defined by the vector v₂. This condition is shown in FIG. 4C;
the capillary 4 is lowered by a predetermined distance Δz₂. This condition is shown in FIG. 4D. Generally, the distance Δz₂ is less than the distance Δz₁ so that, in the following travel movements of the capillary 4, the wire 5 does not rub against or only rubs a little against the semiconductor chip 8; and
the capillary 4 is again moved in horizontal direction by a predetermined distance Δw₂ in the direction defined by the vector v₂. The distance Δw₂ is dimensioned so that the wire 5 tears off. FIG. 4E shows the condition after tearing off the wire 5.

The movement of the capillary 4 in horizontal direction by the distance Δw₁ and the subsequent lowering of the capillary 4 by the distance Δz₂ have the effect that the end of the wire protruding out of the capillary 4 projects in horizontal direction away from the tip of the capillary 4. The travel direction in the direction of the vector v₁ has the effect that the end of the wire takes up the direction of the next wire connection to be made.

These process steps to tear off the wire 5 have the effect that the end of the wire protruding out of the capillary 4 runs parallel to the vector v₁. The capillary 4 is now moved to the first connection point 9.2 of the next wire connection 10.2 to be made and the wire 5 attached to the connection point 9.2. Attachment of the wire 5 is done in that a predetermined bond force and ultrasound are applied to the capillary 4. Because the end of the wire was not previously formed into a ball, the connection created between the wire 5 and the connection point 9.2 is a wedge connection. The wire is now pulled out to the required length in the usual way, formed into a wire loop and attached to the second connection point 11.2. Simultaneously or subsequently the vector v₁ is calculated for the next wire connection 10.3 to be made and the wire torn off in accordance with the process steps described above.

On completion of the last wire connection between a semiconductor chip and the substrate, the vector v is determined for the first wire connection to be made between the next semiconductor chip and the substrate. In this way, all of the semiconductor chips can easily be wired with wedge-wedge connections.

The only problem exists in that, on starting production, the end of the wire protruding out of the capillary does not point in the direction of the vector v₁ corresponding to the first wire connection to be made. This problem can be solved in that either for this wire connection the end of the wire is formed into a ball and the wire attached as a ball connection, or the wire is attached to a suitable position on the substrate, the vector v₁ calculated for the first wire connection to be made and the wire torn off according to the process steps in accordance with the invention. The end of the wire protruding out of the capillary now points in the direction of the vector v₁ and the first wire connection can now also be produced as a wedge-wedge connection.

An important advantage of the invention exists in that the formation of the wire ball is omitted which all in all leads to a shorter cycle time. A further advantage is that the loop height of the produced wedge-wedge connections is less than with ball-wedge connections.

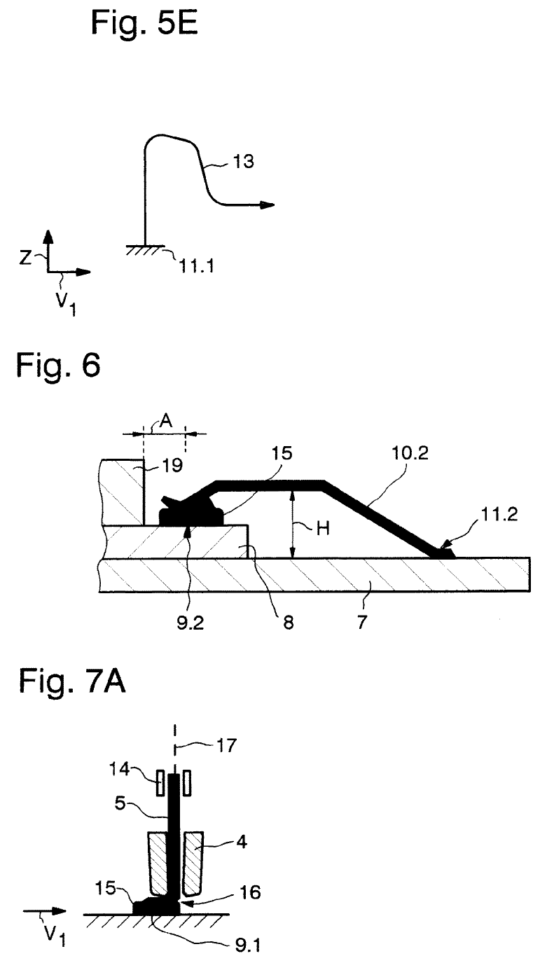

FIG. 5A shows the travel path 13 covered by the capillary 4 (FIG. 4A) after attaching the wire 5 on the second connection point 11.1 up to tearing off the wire 5 in the plane formed by the vector v₁ and the vertical, ie, the z direction, in accordance with the method explained above based on FIGS. 4A to 4E. This travel path consists of two vertical and two horizontal movements the distances of which are designated with Δz₁, Δw₁, Δz₂ and Δw₂. The method in accordance with the invention can also be carried out with slightly modified travel movements of the capillary 4 that are particularly optimised to the effect of eliminating stops during the travel movement. Four examples are presented in the FIGS. 5B to 5E. With the example in FIG. 5B, the movement in horizontal direction by Δw₁ the raising of the capillary 4 by the distance Δz₁ and the lowering of the capillary 4 by the distance Δz₂ are superimposed: The travel path 13 of the capillary 4 is saw-toothed. With the example in FIG. 5C, the lowering of the capillary 4 by the distance Δz₂ is superimposed on the movement in horizontal direction by the distance Δw₁: The travel path 13 of the capillary 4 runs partially along an arc. Furthermore, it is possible to smooth the remaining corner points in the travel path 13 by means of arc-shaped sections in order to prevent as far as possible the unavoidable occurrence of oscillations of the capillary 4 on abrupt stopping of the capillary 4 and therefore to achieve a shorter cycle time. The travel paths 13 presented in the examples in FIGS. 5B and 5C are presented modified in this way in the FIGS. 5D and 5E. The wire 5 tears away from the wire connection 10.1 (FIG. 2) at the latest when the capillary 4 has completely covered the travel path 13.

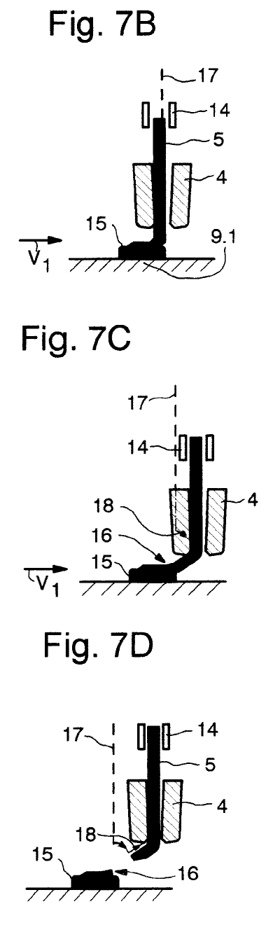

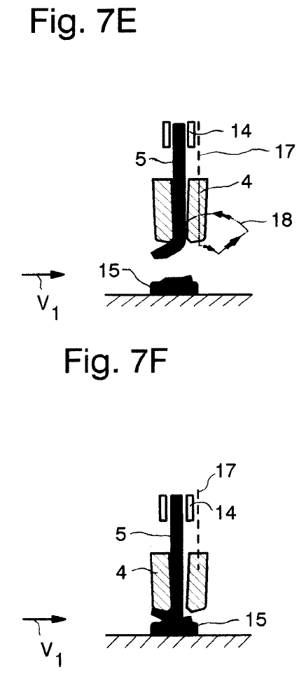

The second embodiment of the invention concerns an application with which the wire connections 10.1, 10.2, etc., between the connections points 9.1, 9.2, etc., on the semiconductor chip 8 and the connection points 11.1, 11.2, etc., on the substrate 7 presented in FIG. 2 are reinforced by additional wire material applied to the connection points 9.1, 9.2, etc., on the semiconductor chip 8 in the form of a “bump”. With this embodiment one wire connection after the other is produced in that a “bump”, or more precisely a so-called “ball bump”, is first applied to the connection point on the semiconductor chip 8, then the capillary 4 is moved in the direction of the wire connection to be made until the wire 5 tears off, then the capillary 4 is moved back over the bump and then a wedge-wedge wire connection is made from the bump to the connection point on the substrate 7. Production of the wire connection 10.2 presented in FIG. 6 is now explained based on the FIGS. 7A to 7F that show a vertical section of a vertical plane aligned in the direction of the wire connection 10.2, ie, a plane formed by the vector v₁ and the vertical. FIG. 7A to FIG. 7F also show the condition—open or closed—of a wire clamp 14. A fixed reference axis 17 serves to illustrate the respective horizontal position of the capillary 4 in the direction of the vector v₁.

FIG. 7A shows the condition after the piece of wire protruding out of the capillary 4 has been melted into a ball and attached to the first connection point 9.2 on the semiconductor chip 8 and before the wire 5 is torn off. On attaching, the melted ball is pressed flat. The wire 5 is still connected to the flat pressed ball 15 but is already pre-formed with a predetermined breaking point 16 at which the wire 5 is to be torn off. The capillary 4 is now raised to the so-called tail height so that the piece of wire protruding out of the capillary 4, the so-called “tail”, has the required length after later tearing off the wire 5. This condition is shown in FIG. 7B. The capillary 4 is now moved simultaneously sideways and upwards, preferably along an arc centered on the predetermined breaking point 16, whereby the horizontal component of this travel movement points in the direction of the wire connection 10.2 to be made. The trajectory path covered by the capillary 4 is presented with the reference 18. This direction is defined by the connecting line between the desired impact point of the capillary 4 on the first connection point 9.2 and the second connection point 11.2. This connecting line corresponds to the wire connection 10.2 presented in FIG. 2 as vector v₁. When the movement takes place along an arc centered on the predetermined breaking point 16, the predetermined breaking point 16 is not strained and the wire 5 does not yet tear off. This condition is shown in FIG. 7C. The wire clamp 14 is now closed and the capillary 4 is moved further away from the first connection point 9.1 preferably along a line connecting the predetermined breaking point 16 and the opening of the capillary 4. Because the wire clamp 14 is closed, the wire 5 tears off, namely at the predetermined breaking point 16. The formation of the “ball bump” is now completed and the piece of wire protruding out of the capillary 4 is aligned in the direction of the wire connection 10.1 to be made. This condition is shown in FIG. 7D. The capillary 4 is now moved back over the “ball bump” (FIG. 7E) and lowered (FIG. 7F) and the piece of wire protruding out of the capillary 4 is attached to the “ball bump” by means of pressure and ultrasound. Afterwards, the wire connection 10.2 is completed in the customary way in that the wire 5 is pulled out to the required length, formed as usual into a wire loop and attached to the second connection point with a wedge connection.

The essential advantages of the invention are:
the loop height H (FIG. 6) is less than with a ball-wedge wire connection;
the wedge-wedge wire connection can be produced without so-called reverse movements that are necessary with a ball-wedge wire connection in order to pre-form the wire loops so that the wire connection has the desired kinks. In this way, the space requirement for the connection points 9.1, 9.2, etc., is reduced which, particularly for “stacked die” applications, offers the advantage that the minimum distance A between the connection point 9.1 and a further adjacently arranged semiconductor chip 19 can be smaller than when a ball connection has to be made starting from the connection point 9.1, 9.2, etc.;
the time required for a bond cycle is less than with the Ball-Bump-Reverse-Loop method as, per wire connection, the wire only has to be melted into a ball once and not twice.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

1. Method for producing wedge-wedge wire connections each between a first connection point and a second connection point by means of a Wire Bonder, wherein the wire is guided by a capillary that is secured to a horn, whereby a bondhead enables movements of the horn characterized by a total of three degrees of freedom and wherein the following steps are carried out in order to complete the wedge-wedge wire connection by means of tearing off the wire and to prepare the piece of wire protruding out of the capillary for producing a next wedge-wedge wire connection to be made:
calculating a two-dimensional vector v lying in a horizontal plane that points from a desired impact point of the capillary on the first connection point of the next wedge-wedge wire connection to be made towards a desired impact point of the capillary on the second connection point of the next wedge-wedge wire connection to be made, and
after attaching the wire to the second connection point, moving the capillary along a travel path that lies in a plane formed by the vector v and the vertical.

2. Method for producing a wire connection between a first connection point and a second connection point by means of a Wire Bonder, whereby the wire is guided by a capillary that is secured to a horn and whereby the bondhead enables movements of the horn characterized by a total of three degrees of freedom comprising the following steps:
melting the piece of wire protruding out of the capillary into a ball,
calculating a two-dimensional vector v lying in a horizontal plane that points from a desired impact point of the capillary on the first connection point towards a desired impact point of the capillary on the second connection point,
formation of a bump on the first connection point by
attaching the ball to the first connection point, and
moving the capillary along a travel path that lies in a plane formed by the vector v and the vertical in order to align and then tear off the wire in the direction of the vector v,
moving the capillary back over the bump that has just been produced,
attaching the piece of wire protruding out of the capillary to the bump,
pulling the wire out to the required length and attaching the wire to the second connection point.
